(19) United States
(12) Patent Application Publication
(10) Pub. No.: US 2015/0141585 A1
(43) Pub. Date: May 21, 2015

(54) COMPOSITION BASED ON SILANE-TERMINATED POLYMERS THAT DOES NOT SPLIT OFF METHANOL DURING CURING

(71) Applicant: SIKA TECHNOLOGY AG, Baar (CH)

(72) Inventors: Fabien Choffat, Ruttenen (CH); Manuel Nestler, Uster (CH)

(21) Appl. No.: 14/398,583

(22) PCT Filed: May 23, 2013
(86) PCT No.: PCT/EP2013/060657

§ 371 Date: Nov. 3, 2014

(30) Foreign Application Priority Data
May 23, 2012 (EP) 12169153.9

(51) Int. Cl. C08G 18/83; C09J 175/08; C08G 18/22

(52) U.S. Cl. CPC C08G 18/833; C08G 18/837; C08G 18/222; C09J 175/08
USPC 525/460; 252/182.14

(57) ABSTRACT

The invention relates to a composition including a) at least one silane-functional polymer P having alkoxy end groups, which are not methoxy groups; b) at least one catalyst for the cross-linking of silane-functional polymers, selected from the group comprising an organotitanate, organozirconate and organoaluminate; c) at least one compound having at least one amidino group. Such compositions are suitable as adhesives, sealants and coatings and have the advantage that the compositions are substantially free from tin or organic tin compounds and do not split off methanol during curing.

### TECHNICAL AREA

The present invention relates to the area of elastic adhesives, sealants and coatings based on silane-functional polymers.

### PRIOR ART

Compositions based on silane-functional polymers and their use as adhesives, sealants or coatings have long been known and have been described many times. Polymers provided with various moisture-reactive silane groups are used as silane-functional polymers. The essential criterion for selecting the silane groups in these cases is the reactivity of these groups. Finally, the curing rate of the composition is decisively influenced by the reactivity of the silane groups.

It is known that particularly good reactivities are achieved with two systems. They are, on one hand, compositions based on methoxysilane-terminated polymers, and on the other hand those based on α-silane-terminated polymers. The latter in turn are particularly reactive when they contain methoxy groups.

The drawback of the use of methoxysilane-terminated polymers is that they split off methanol during cross-linking with water. The release of methanol is particularly problematic in the case of use in interior rooms, since methanol and especially its metabolites are toxic to humans and can cause adverse effects.

An additional drawback of methoxysilane-terminated polymers is that they are preferably cured with the aid of organic tin compounds, which in turn are not suitable for all applications because of environmental and toxicologic reasons.

The drawback of α-silane-terminated polymers is that they are very expensive to manufacture and thus are not commercially available or are too expensive.

### Presentation of the Invention

Therefore the goal of the present invention is to supply a composition based on silane-functional polymers which overcome the drawbacks of the prior art and cures completely without tin or organ-tin compounds and without releasing methanol.

Surprisingly it has now been found that compositions according to claim 1 solve this problem.

The combination of specific catalysts with compounds which have at least one amidino group leads to the fact that compositions based on silane-functional polymers with alkoxy end groups which are not methoxy end groups cure completely, release no methanol, and are completely or substantially free from tin or organic tin compounds.

Additional aspects of the invention form the subject matter of further independent claims. Particularly preferred embodiments of the invention form the subject matter of the dependent claims.

### Methods of Performing the Inventions

The subject matter of the present invention is a composition comprising
a) at least one silane-functional polymer P with alkoxy end groups which are not methoxy groups;
b) at least one catalyst for the cross-linking of silane-functional polymers, selected from the group consisting of an organotitanate, organozirconate and organoaluminate;
c) at least one compound containing at least one amidino group.

Substance names beginning with “poly” such as polyol or polyisocyanate in the present document designate substances which formally contain two or more of the functional groups occurring in their name per molecule.

The term “polymer” in the present document covers on one hand a group of macromolecules that are chemically uniform but differ in terms of degree of polymerization, molecular weight and chain length, produced by a polyreaction (polymerization, polyaddition, polycondensation). On the other hand, the term also covers derivatives of such a group of macromolecules from polyreactions, thus compounds that were obtained by reactions, for example, additions or substitutions, of functional groups on specified macromolecules and which may be chemically homogeneous or chemically inhomogeneous. The term also comprises so-called prepolymers, in other words reactive oligomeric preadducts, the functional groups of which are involved in the buildup of macromolecules.

The term “polyurethane polymer” covers all polymers produced according to the so-called diisocyanate polyaddition method. This also includes polymers that are almost free or completely free from urethane groups. Examples of polyurethane polymers are polyether polyurethanes, polyester polyurethanes, polyether polyureas, polyureas, polyester polyureas, polyisocyanurates and polycarbodiimides.

In the present document the terms “silane” or organosilane” designate compounds which on one hand have at least one, usually two or three, alkoxy groups or acyloxy groups bound directly to the silicon atom over Si—O bonds, and on the other hand at least one organic radical bound directly to the silicon atom over a Si—C bond. Such silanes are also known to the person skilled in the art as organoalkoxysilanes or organoacyloxysilanes. Consequently “tetraalkoxysilanes” are not organosilanes according to this definition.

Correspondingly the term “silane group” designates the silicon-containing group bound to the organic radical of the silane over the Si—C bond. The silanes, or their silane groups, have the characteristic of undergoing hydrolysis upon contact with moisture. In this process, organosilanols form, in other words organosilicon compounds containing one or more silanol groups (Si—OH groups) and by subsequent condensation reactions, organosiloxanes, i.e., organosilicon compounds containing one or more siloxane groups (Si—O—Si groups). The term “silane-functional” refers to compounds that contain silane groups. Thus “silane-functional polymers” are polymers that have at least one silane group.

The terms “aminosilanes” and “mercaptosilanes” are applied to organosilanes, the organic radical of which contains one amino group or one mercapto group respectively. The term “primary aminosilanes” is applied to aminosilanes which have a primary amino group, thus an NH₂ group, bound to an organic radical. “Secondary aminosilanes” is the term applied to aminosilanes that have a secondary amino group, thus an NH group, bound to two organic radicals.

The terms “organotitanate,” “organozirconate” and “organoaluminate” in the present document indicate compounds that have at least one ligand bound over an oxygen atom to the titanium, zirconium or aluminum atom.

In the present document a “multidentate ligand” or “chelate ligand” is defined as a ligand which has at least two free electron pairs and may have at least two coordination sites for the central atom. A bidentate ligand correspondingly may have two coordination sites for a central atom.

The “molecular weight” is always construed in the present document as the number-average molecular weight, Mₙ.

The composition according to the invention contains at least one silane-functional polymer P with alkoxy end groups that are not methoxy groups, wherein these end groups are especially end groups of formula (I).

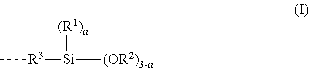

Here the radical R¹ represents an alkyl group with 1 to 8 C atoms, especially a methyl or an ethyl group.

The radical R² represents an alkyl group with 2 to 12 C atoms, especially an alkyl group with 2 to 8 C atoms, preferably an ethyl or an isopropyl group.

The radical R³ represents a linear or branched, optionally cyclic, alkylene group with 1 to 12 C atoms, optionally with aromatic moieties, and optionally with one or more heteroatoms, especially with one or more nitrogen atoms.

The subscript a represents a value of 0 or 1 or 2, especially a value of 0.

Most preferably the radical R² is an ethyl group, i.e., in the composition according to the invention as described in the preceding, the alkoxy end groups of the silane-functional polymer P are methoxy groups.

The advantage of silane-functional polymers that have ethoxy groups as the alkoxy end groups is that upon cross-linking with water, ethanol is released, so that the compositions are safe from the environmental and toxicologic viewpoints.

Within a silane group of formula (I), R¹ and R² each independently represent the radicals described. Thus for example compounds of formula (I) that represent diethoxyisopropoxysilanes (R²—ethyl, R²=ethyl, R²=isopropyl) are possible.

In a first embodiment the silane-functional polymer P is a silane-functional polyurethane polymer P1 which can be obtained by reacting a silane having at least one group reactive toward isocyanate groups with a polyurethane polymer that has isocyanate groups. This reaction is preferably performed in a stoichiometric ratio of the groups reactive toward isocyanates to the isocyanate groups of 1:1 or with a slight excess of groups reactive toward isocyanate groups, so that the resulting silane-functional polymer P1 is completely free from isocyanate groups.

In the reaction of silane containing at least one group reactive toward isocyanate groups with a polyurethane polymer that contains isocyanate groups, the silane can theoretically, although not preferably, be used in a substoichiometric amount, so that a silane-functional polymer is obtained which has both silane groups and isocyanate groups.

The silane, which has at least one group reactive toward isocyanate groups, is preferably a mercaptosilane or an aminosilane, especially an aminosilane.

Preferably the aminosilane is an aminosilane AS of formula (II),

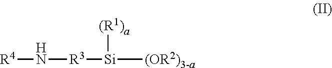

wherein R¹, R², R³ and a were already described in the preceding and R⁴ represents a hydrogen atom or a linear or branched, monovalent hydrocarbon radical with 1 to 20 C atoms which optionally has cyclic portions, or a radical of formula (III).

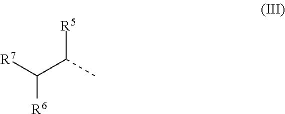

Here, the radicals R⁵ and R⁶ each independently of one another represent a hydrogen atom or a radical from the group consisting of —R⁸, —COOR⁸ and —CN.

The radical R⁷ represents a hydrogen atom or a radical from the group consisting of CH₂—COOR⁸, COOR⁸, CONHR⁸, CON(R⁸)₂, CN, NO₂, PO(OR⁸)₂, SO₂R⁸ and SO₂OR⁸.

The radical R⁸ represents a hydrocarbon radical with 1 to 20 C atoms, optionally containing at least one heteroatom.

Examples of suitable aminosilanes AS are primary aminosilanes such as 3-aminopropyltriethoxysilane, 3-aminopropyldiethoxymethylsilane; secondary aminosilanes such as N-butyl-3-aminopropyltriethoxysilane, N-phenyl-3-aminopropyltriethoxysilane; the products of the Michael-like addition of primary aminosilanes such as 3-aminopropyltriethoxysilane or 3-aminopropyldiethoxymethylsilane to Michael acceptors such as acrylonitrile, (meth)acrylic acid esters, (meth) acrylic acid amides, maleic acid and fumaric acid diesters, citraconic acid diesters and itaconic acid diesters, for example, N-(3-triethoxysilylpropyl)-amino-succinic acid dimethyl and diethyl esters; as well as analogs of the aminosilanes mentioned with isopropoxy, n-propoxy and corresponding butoxy, pentoxy, hexoxy, heptoxy and octoxy groups instead of the ethoxy groups on the silicon. Particularly suitable aminosilanes AS are secondary aminosilanes, especially aminosilanes AS in which R⁴ in formula (II) is different from H. The Michael-type adducts, especially N-(3-triethoxysilyl-propyl)-amino-succinic acid diethyl ester, are preferred.

The term “Michael acceptor” in the present document designates compounds that are capable, because of the double bonds present in them and activated by electron acceptor radicals, of undergoing nucleophilic addition reactions with primary amino groups (NH₂ groups) in a manner analogous to the Michael addition (hetero-Michael addition).

Suitable aminosilanes also particularly include those that can be obtained from the reaction of an N-aminoethyl-aminoalkyltrialkoxysilane in which the alkoxy end groups are not methoxy end groups with a maleic or fumaric acid diester. Such suitable aminosilanes are described, for example, in WO 01/00632, the overall disclosure of which is herewith incorporated by reference. Silane-terminated polyurethane polymers produced with corresponding aminosilanes are described, for example, in the European Patent application with application number EP 09153120.2, the overall disclosure of which is also herewith incorporated by reference. The methoxysilane group-containing aminosilanes or silane-terminated polyurethane polymers described in the documents mentioned are unsuitable for the present invention.

Suitable polyurethane polymers containing isocyanate groups for producing a silane-functional polyurethane polymer P1, for example, are polymers that can be obtained by reacting at least one polyol with at least one polyisocyanate, especially a diisocyanate. This reaction can be performed by reacting the polyol and the polyisocyanate using conventional methods, for example at temperatures of 50° C. to 100° C., optionally using suitable catalysts, wherein the polyisocyanate quantity added is such that its isocyanate groups are present in stoichiometric excess relative to the hydroxyl groups of the polyol.

In particular the excess of polyisocyanate is selected such that after reaction of all of the hydroxyl groups of the polyol, the resulting polyurethane polymer has a free isocyanate group content of 0.1 to 5 wt %, preferably 0.1 to 2.5 wt %, particularly preferably 0.2 to 1 wt %, based on the total polymer.

Optionally the polyurethane polymer can be produced using plasticizers, wherein the plasticizers used do not contain any groups reactive with isocyanate.

Preferred are polyurethane polymers with the reported contents of free isocyanate groups, which were obtained from the reaction of diisocyanates with high molecular weight diols in an NCO:OH ratio of 1.5:1 to 2.2:1.

Suitable polyols for producing the polyurethane polymers in particular are polyether polyols, polyester polyols and polycarbonate polyols as well as mixtures of these polyols.

Particularly suitable as polyether polyols, also known as polyoxyalkylene polyols or oligoetherols, are those that are polymerization products of ethylene oxide, 1,2-propylene oxide, 1,2- or 2,3-butylene oxide, oxetane, tetrahydrofuran or mixtures thereof, optionally polymerized with the aid of a starter molecule with two or more active hydrogen atoms, for example water, ammonia or compounds with several OH- or NH-groups, such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, as well as mixtures of the compounds named. Polyoxyalkylene polyols that have a low degree of unsaturation (measured according to ASTM D-2849-69 and given in milliequivalent of unsaturation per gram of polyol (mEq/g)), produced for example with the aid of so-called double metal cyanide complex catalysts (DMC catalysts), as well as polyoxyalkylene polyols with a higher degree of unsaturation, produced for example with the aid of anionic catalysts such as NaOH, KOH, CsOH or alkali alcoholates, can be used.

Particularly suitable are polyoxyethylene polyols and polyoxypropylene polyols, especially polyoxyethylene diols, polyoxypropylene diols, polyoxyethylene triols and polyoxypropylene triols.

Especially particularly suitable are polyoxyalkylene diols or polyoxyalkylene triols with a degree of unsaturation of less than 0.02 mEq/g and with a molecular weight in the range of 1000 to 30,000 g/mol, as well as polyoxyethylene diols, polyoxyethylene triols, polyoxypropylene diols and polyoxypropylene triols with a molecular weight of 400 to 20,000 g/mol.

Also particularly suitable are so-called ethylene oxide-terminated (“EO-endcapped”, ethylene oxide-endcapped) polyoxypropylene polyols. The latter are especially polyoxypropylene-polyoxyethylene polyols, obtained for example in that pure polyoxypropylene polyols, especially polyoxypropylene diols and triols, are further alkoxylated after completion of the polyoxypropylation reaction with ethylene oxide and thus have primary hydroxyl groups. In this case polyoxypropylene-polyoxyethylene diols and polyoxypropylene-polyoxyethylene triols are preferred.

Also suitable are hydroxyl group-terminated polybutadiene polyols, for example those produced by polymerization of 1,3-butadiene and allyl alcohol or by oxidation of polybutadiene, as well as the hydrogenation products thereof.

Also suitable are styrene-acrylonitrile grafted polyether polyols, such as those commercially available under the trade name of Lupranol® from Elastogran GmbH, Germany.

Particularly suitable as polyester polyols are polyesters that have at least two hydroxyl groups and that are produced according to known methods, especially the polycondensation of hydroxycarboxylic acids or polycondensation of aliphatic and/or aromatic polycarboxylic acids with alcohols containing two or more hydroxyl groups.

Especially suitable are polyester polyols produced from dihydric to trihydric alcohols, for example 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or the anhydrides or esters thereof, for example succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic acid anhydride, isophthalic acid, terephthalic acid, dimethylterephthalate, hexahydrophthalic acid, trimellitic acid and trimellitic acid anhydride or mixtures of the above-named acids, as well as polyester polyols consisting of lactones such as 8-caprolactone.

Particularly suitable are polyesterdiols, especially those prepared from adipic acid, azelaic acid, sebacic acid, dodecane dicarboxylic acid, dimer fatty acid, phthalic acid, isophthalic acid and terephthalic acid as dicarboxylic acid, or from lactones such as 8-caprolactone and from ethylene glycol, diethylene glycol, neopentyl glycol, 1,4-butanediol, 1,6-hexanediol, dimer fatty acid diol and 1,4-cyclohexane dimethanol as dihydric alcohol.

Suitable polycarbonate polyols in particular are those that can be obtained by reacting for example the above-mentioned alcohols, used for building up the polyester polyols, with dialkyl carbonates such as dimethyl carbonate, diaryl carbonates such as diphenyl carbonate or phosgene. Particularly suitable are polycarbonate diols, especially amorphous carbonate diols.

Additional suitable polyols are poly(meth)acrylate polyols.

Also suitable are polyhydroxy functional fats and oils, for example natural fats and oils, especially castor oil, or polyols obtained by chemical modification of natural fats and oils, so-called oleochemical polyols, epoxy polyesters or epoxy polyethers obtained for example by epoxidation of unsaturated oils and subsequent ring opening with carboxylic acids or alcohols, or polyols obtained by hydroformylation and hydrogenation of unsaturated oils. Also suitable are polyols obtained from natural fats and oils by degradation processes such as alcoholysis or ozonolysis and subsequent chemical bonding, for example by ester exchange or dimerization, of the degradation products or derivatives obtained in this way. Suitable degradation products of natural fats and oils in particular are fatty acids and fatty alcohols as well as fatty acid esters, especially the methyl esters (FAME), which can be derivatized for example by hydroformylation and hydrogenation to form hydroxy fatty acid esters.

Additionally likewise suitable are polyhydrocarbon polyols, also known as oligohydrocarbonols, for example polyhydroxy functional ethylene-propylene, ethylene-butylene or ethylene-propylene-diene copolymers, as are produced for example by Kraton Polymers, USA, or polyhydroxy functional copolymers from dienes such as 1,3-butanediene or diene mixtures and vinyl monomers such as styrene, acrylonitrile or isobutylene, or polyhydroxy functional polybutadiene polyols, for example those that can be produced by copolymerization of 1,3-butadiene and allyl alcohol and can also be hydrogenated.

Also suitable are polyhydroxy functional acrylonitrile/butadiene copolymers, for example those produced from epoxides or amino alcohols and carboxyl-terminated acrylonitrile-butadiene copolymers commercially available under the name of Hypro® (formerly Hycar®) CTBN from Emerald Performance Materials, LLC, USA.

These polyols mentioned preferably have an average molecular weight of 250 to 30,000 g/mol, especially 1000 to 30,000 g/mol and an average OH functionality in the range of 1.6 to 3.

Particularly suitable polyols are polyester polyols and polyether polyols, especially polyoxyethylene polyol, polyoxypropylene polyol and polyoxypropylene-polyoxyethylene polyol, preferably polyoxyethylene diol, polyoxypropylene diol, polyoxyethylene triol, polyoxypropylene triol, polyoxypropylene-polyoxyethylene diol and polyoxypropylenepolyoxyethylene triol.

In addition to the polyols mentioned, small quantities of low molecular weight dihydric or polyhydric alcohols such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher hydric alcohols, low molecular weight alkoxylation products of the aforementioned dihydric and polyhydric alcohols, and mixtures of the aforementioned alcohols may simultaneously be used in the production of the polyurethane polymers with terminal isocyanate groups.

Commercial polyisocyanate that may be used for producing polyurethane polymer are commercial polyisocyanates, especially diisocyanates.

For example, suitable diisocyanates include 1,6-hexamethylene diisocyanate (HDI), 2-methylpentamethylene-1,5-diisocyanate, 2,2,4- and 2,4,4-trimethyl-1,6-hexamethylene diisocyanate (TMDI), 1,12-dodecamethylene diisocyanate, lysine and lysine ester diisocyanate, cyclohexane-1,3-diisocyanate, cyclohexane-1,4-diisocyanate, 1-isocyanato-3,3,5-trimethyl-5-isocyanatomethyl-cyclohexane (=isophorone diisocyanate or IPDI), perhydro-2,4′-diphenylmethane diisocyanate and perhydro-4,4′-diphenylmethane diisocyanate, 1,4-diisocyanato-2,2,6-trimethyl-cyclohexane (TMCDI), 1,3- and 1,4-bis-(isocyanatomethyl)-cyclohexane, m- and p-xylylene diisocyanate (m- and p-XDI), m- and p-tetramethyl-1,3-xylylene diisocyanate, m- and p-tetramethyl-1,4-xylylene diisocyanate, bis-(1-isocyanato-1-methylethyl)naphthalene, 2,4- and 2,6-toluylene diisocyanate (TDI), 4,4′-, 2,4′- and 2,2′-diphenylmethane diisocyanate (MDI), 1,3- and 1,4-phenylene diisocyanate, 2,3,5,6-tetramethyl1,4-diisocyanatobenzene, naphthalene-1,5-diisocyanate (NDI), 3,3′-dimethyl4,4′diisocyanatodiphenyl (TODI), oligomers and polymers of the aforementioned isocyanates, and arbitrary mixtures of the above-mentioned isocyanates.

In a second embodiment the silane-functional polymer P is a silane-functional polyurethane polymer P2, obtainable by reacting an isocyanatosilane IS with a polymer that has functional end groups, especially hydroxyl groups, mercapto groups and/or amino groups, that are reactive toward isocyanate groups. This reaction takes place in a stoichiometric ratio of the isocyanate groups to the end groups reactive toward isocyanate groups of 1:1, or with a slight excess of the functional groups reactive toward isocyanate groups, for example at temperatures of 20° C. to 100° C., optionally with simultaneous use of catalysts.

Suitable isocyanatosilane groups IS are compounds of formula (IV).

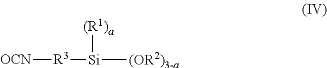

The R¹, R², R³ and a in this formula have been described previously. Examples of suitable isocyanatosilanes IS of formula (IV) are isocyanatomethyl triethoxysilane, isocyanatomethyl diethoxymethyl silane 3-isocyanatopropyltriethoxysilane, 3-isocyanatopropyldiethoxymethylsilane and the analogues thereof with isopropoxy groups in place of ethoxy groups on the silicon. The polymer preferably has hydroxyl groups as functional end groups reactive toward isocyanato groups.

Suitable hydroxyl group-containing polymers are on one hand the already-mentioned high-molecular-weight polyoxyalkylene polyols, preferably polyoxypropylene diols with a degree of unsaturation less than 0.02 mEq/g and with a molecular weight in the range of 4000 to 30,000 g/mol, especially with a molecular weight in the range of 8000 to 30,000 g/mol. Also suitable for reaction with isocyanatosilanes IS of formula (IV) are hydroxyl group-containing, especially hydroxyl group-terminated, polyurethane polymers for reaction with isocyanatosilanes IS of formula (IV). Such polyurethane polymers can be obtained by reacting at least one polyisocyanate with at least one polyol. This reaction can be performed in that the polyol and the polyisocyanate are reacted together by the usual methods, for example at temperatures of 50° C. to 100° C., optionally with simultaneous use of suitable catalysts, wherein the polyol is added at such a rate that the hydroxyl groups thereof are present in stoichiometric excess relative to the isocyanate groups of the polyisocyanate. A ratio of hydroxyl groups to isocyanate groups of 1.3:4.1, especially of 1.8:1 to 3.1 is preferred.

Optionally the polyurethane polymer can be produced using plasticizers, wherein the plasticizers used do not contain any groups reactive toward isocyanates.

The same polyols and polyisocyanates that were previously mentioned as suitable for producing an isocyanate group-containing polyurethane polymer and used for producing a silane-functional polyurethane polymer P1 are suitable for this reaction.

For example silane-functional polymers P2 are commercially available under the trade name Silquest® A-Link Silanes from Momentive Performance Materials, Inc., U.S.A.

In a third embodiment the silane-functional polymer P is a silane-functional polymer P3 which can be obtained by a hydroxysilylation reaction of polymers with terminal double bonds, for example poly(meth)acrylate polymers or polyether polymers, especially of allyl-terminated polyoxyalkylene polymers, described for example in U.S. Pat. No. 3,971,751 and U.S. Pat. No. 6,207,766, the entire disclosure of which is herewith incorporated. The methoxysilane group-containing silane-terminated polymers described in the documents mentioned are unsuitable for the present invention.

The silane-functional polymer P is preferably a silane-functional polymer P1 or P2, especially P1.

Compared with the silane-functional polymer P3, silane-functional polymers P1 and P2 have the advantage that they are more reactive and thus undergo more rapid cross-linking. An additional advantage lies in the fact that they have improved mechanical properties which are comparable to those of standard polyurethane compositions. Furthermore they have a lower tendency toward creeping behavior and improved resilience. These characteristics are especially pronounced in the case of silane-functional polymers P1, so that these are generally preferred. Through the totality of these properties, preferred compositions are especially suitable for use in joints, especially in dilatation joints.

The silane-functional polymer P is usually present in a quantity of 10 to 80 wt %, especially in a quantity of 15 to 50 wt %, preferably 20 to 40 wt %, based on the total composition.

In addition the composition according to the invention comprises at least one catalyst for the cross-linking of silane-functional polymers, selected from the group consisting of an organotitanate, an organozirconate and an organoaluminate.

Here the term “catalyst” also designates a cross-linking agent and cross-linking-active substances that are effective at low concentrations. In the formulas presented the broken line represents the bond of the oxygen to the metal.

Suitable organotitanates, organozirconates and organoaluminates have ligands that are selected from the group consisting of alkoxy group, sulfonate group, carboxylate group, dialkyl phosphate group, dialkyl pyrophosphate group and acetylacetonate group, wherein all ligands may be identical to or different from one another.

In particular so-called neoalkoxy substituents, especially of formula (V), have proven particularly suitable as alkoxy groups.

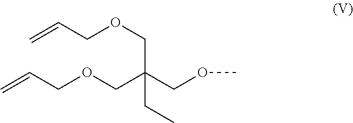

Particularly suitable sulfonic acids have been found to be aromatic sulfonic acids, aromatic [rings] of which are substituted with an alkyl group. Radicals of formula (VI) are considered preferred sulfonic acids.

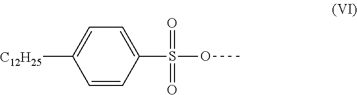

In particular, especially suitable carboxylate groups were found to be carboxylates of fatty acids. Decanoate, stearate and isostearate are preferred carboxylates.

In particular the catalyst for the cross-linking of silane-functional polymers has at least one multidentate ligand, also known as a chelate ligand. In particular the multidentate ligand is a bidentate ligand.

The bidentate ligand is particularly a ligand of formula (VII)

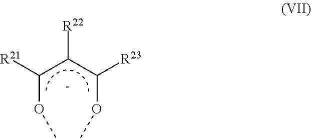

Here the radical R²¹ represents a hydrogen atom or a linear or branched alkyl group with 1 to 8 C atoms, especially a methyl group.

The radical R²² represents a hydrogen atom or a linear or branched alkyl group with 1 to 8 C atoms, optionally containing heteroatoms, especially a hydrogen atom.

The radical R²³ represents a hydrogen atom or an alkyl group with 1 to 8, especially 1 to 3, C atoms or a linear or branched alkoxy group with 1 to 8, especially 1 to 3, C atoms.

The catalyst for the cross-linking of silane-functional polymers is especially an organotitanate, especially an organotitanate of formula (VIII).

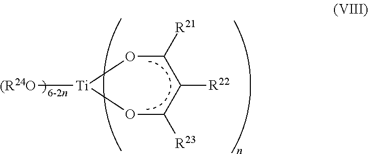

The radicals R²¹, R²² and R²³ were described previously.

The radical R²⁴ represents a linear or branched alkyl radical with 2 to 20 C atoms, especially an isobutyl or isopropyl radical.

n represents a value of 1 or 2, especially 2.

Organotitanates of formula (VIII), in which the radical R²¹ represents a methyl group, the radical R²² represents a hydrogen atom, the radical R²³ represents a methyl group or methoxy or ethoxy group and the radical R²⁴ represents an isobutyl or isopropyl radical, are preferred.

Organotitanates have the advantage that a higher cross-linking speed can be achieved.

Suitable organotitanates are, for example, commercially available under the trade names Tyzor® AA, GBA, GBO, AA-75, AA-65, AA-105, DC, BEAT, IBAY from DuPont, USA, or under the trade names Tytan™ PBT, TET, X85, TAA, ET, S2, S4 or S6 from TensoChema AG, Switzerland.

Organozirconates are commercially available, for example from Kenrich Petrochemicals. Suitable organozirconates are for example Ken-React® NZ 38J, NZ TPPJ, KZ OPPR, KZ TPP, NZ 01, NZ 09, NZ 12, NZ38, NZ 44, NZ 97. Additional suitable organozirconates are commercially available under the trade names Snapcure™ 3020, 3030, 1020 from Johnson Matthey & Brandenberg AG, Switzerland.

Suitable organoaluminates are, for example, commercially available under the trade name K-Kat® 5218 from the firm of Worlée-Chemie GmbH, Germany.

Naturally it is possible for in some cases even preferred to use mixtures of various catalysts.

The fraction of the catalyst preferably amounts to 0.1 to 10 wt %, especially 0.2 to 4 wt %, preferably 0.3 to 3 wt %, most preferably 0.5 to 1.5 wt %, of the total composition.

In addition the composition according to the invention comprises at least one compound which has at least one amidino group. In particular this involves a compound of formula (IX).

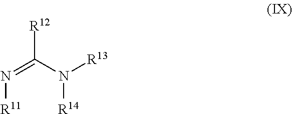

Here the radical R¹¹ represents a hydrogen atom, a monovalent hydrocarbon radical with 1 to 10 C atoms or, together with R¹⁴, an optionally substituted divalent hydrocarbon radial with 1 to 10 C atoms.

The radical R¹² represents a hydrogen atom, a monovalent hydrocarbon radical with 1 to 12 C atoms, optionally with cyclical aromatic fractions, and optionally with one or more hetero atoms, an amino group, or together with R¹³, an optionally substituted, divalent hydrocarbon group with 1 to 10 C atoms.

The radical R¹³ represents a hydrogen atom, a monovalent hydrocarbon radical with 1 to 12 C atoms, optionally with cyclic or aromatic fractions, and optionally with one or more hetero atoms, or together with R¹² represents an optionally substituted, divalent hydrocarbon radical with 1 to 10 C atoms.

The radical R¹⁴ represents a hydrogen atom, a monovalent hydrocarbon radical with 1 to 10 C atoms, or together with R¹¹ represents an optionally substituted, divalent hydrocarbon radical with to 10 C atoms.

For example the radical R¹² or R¹³, which contains hetero atoms, is an alkyl radical containing a silane group, for example an alkyltrialkoxysilane radical, wherein the silane group has no methoxy groups.

Preferably the compound containing at least one amino group is a guanidine, an imidazole, an imidazoline, a bicyclic amidine or a derivative of these compounds. Examples of such derivatives are substituted imidazoles or imidazolines, especially a silane group—containing imidazole or imidazoline, wherein the silane group has no methoxy groups.

Preferred compounds that have at least one amidino group are 1,8-diazabicyclo[5.4.0]undec-7-ene (DBU), 1,5-diazabicyclo[4.3.0]non-5-ene (DBN), 6-(dibutylamino)1,8-diazabicyclo[5.4.0]undec-7-ene, N-methyltriazabicyclodecene, tetramethylguanidine, 2-guanidinobenzimidazole, acetylacetone guanidine, 1,3-di-o-tolylguanidine (DTG), 1,3-diphenylguanidine, o-tolylbiguanidine, 2-tert-butyl-1,1,3,3-tetramethylguanidine (or N-(3-triethoxysilylpropyl)-4,5-dihydroimidazole.

The fraction of the compound that has at least one amidino group preferably amounts to 0.05 to 3 wt %, especially 0.1 to 2 wt %, preferably 0.2 to 1 wt %, of the total composition. Most preferably the fraction of the compound that has at least one amidino group is ≦0.5 wt %, especially 0.3 to 0.5 wt %, preferably 0.4 to 0.45 wt %. In the case of fractions of more than 0.5 wt %, sweating of the compound out of the cured composition may occur, which is disadvantageous for certain applications (visual appearance, easy soiling, etc.).

Preferably the amidine is a bicyclic amidine, especially with 9, 10, 11 or 12 carbon atoms in the bicyclic component. The advantage of these compounds is that they have a higher reactivity and their content can therefore be kept relatively low. As a result, once again sweating of these compounds out of the cured composition can be reduced.

Preferably the composition according to the invention is substantially free from tin or organic tin compounds. In particular the composition amounts to <0.06 wt %, especially <0.01 wt %, tin or organic tin compounds. Preferably the composition contains no tin or organic tin compounds, such as are usually used for curing compositions based on silane-terminated polymers. Tin-free compositions have both environmental and toxicologic advantages. A composition that is free from tin and organic tin compounds presumes that individual constituents of the composition were not produced under the influence of tin or organic tin compounds. Typically therefore the manufacturing of the silane-functional polymer P takes place without the influence of tin or organic tin compounds.

Preferably the composition also contains a filler. The filler influences both the rheologic properties of the non-cured composition and the mechanical properties and surface composition of the cured composition. Suitable fillers are inorganic and organic fillers, for example natural, ground or precipitated calcium carbonate, which are optionally coated with fatty acids, especially stearic acid, barium sulfate (BaSO₄, also called baryta or heavy spar), calcined kaolins, aluminum oxides, aluminum hydroxides, silicas, especially highly dispersed silicas from pyrolysis processes, carbon black, especially industrially manufactured carbon black, PVC powder or hollow beads. Preferred fillers are calcium carbonate, calcium kaolin, carbon black, highly dispersed silicas and flame-retardant fillers such as hydroxides or hydrates, especially hydroxides or hydrates of aluminum, preferably aluminum hydroxide. It is entirely possible and may even be advantageous to use a mixture of various fillers.

For example a suitable quantity of filler falls in the range of 10 to 70 wt %, especially 15 to 60 wt %, preferably 30 to 60 wt %, based on the total composition.

In addition the composition according to the invention may also contain additional constituents. For example such constituents are plasticizers such as esters of organic carboxylic acids or anhydrides thereof, such as phthalates, for example dioctyl phthalate, diisononyl phthalate or diisodecyl phthalate, adipates, for example dioctyl adipate, azelates and sebacates, polyols, for example polyoxyalkylene polyols or polyester polyols, organic phosphoric and sulfonic acid esters or polybutenes; solvents; fibers, for example made of polyethylene; dyes; pigments; rheology modifiers such as thickeners or thixotropic agents, for example urea compounds of the type described as thixotropic agents “Thixotropy endowning agent”) in WO 02/48228 A2 on pages 9 to 11, polyamide waxes, bentonites or pyrogenic silicas; adhesion promoters, for example epoxy silanes, (meth)acrylsilanes, anhydridosilanes or adducts of the aforementioned silanes with primary aminosilanes, as well as aminosilanes or urea silanes; cross-linking agents, for example silane-functional oligomers and polymers; drying agents, for example, vinyl triethoxysilane, α-functional silanes such as N-(silylmethyl)-O-methyl-carbamates, especially N-(methyldiethoxy silylmethyl)-O-methyl-carbamate, (methacryloxymethyl) silanes, ethoxy-methylsilanes, N-phenyl-, N-cyclohexyl- and N-alkylsilanes, orthoformic acid esters, calcium oxide or molecular sieves; stabilizers, for example against heat, light and UV radiation; flame-retardant substances; surface-active substances such as wetting agents, leveling agents, deaerating agents, defoamers; biocides such as algicides, fungicides or fungal growth-inhibiting substances; and additional substances usually used in moisture-curing compositions.

In addition, so-called reactive diluents may also be used, which during curing of the composition, especially with the silane groups, are incorporated to the polymer matrix.

The composition according to the invention especially contains no constituents that split off methanol upon curing. Such constituents are present along with the silane-functional polymers P and optionally reactive constituents such as adhesives, drying agents, reactive diluents, cross-linking agents and other above-described constituents.

Constituents that split off methanol when curing are typically methoxy group-containing silane-functional compounds. Thus in particular the composition according to the invention contains no silane-functional compositions that have methoxy silane groups.

Preferably all silane-functional compounds present in the composition have end groups of formula (I), wherein the radicals are R¹, R² and R³ as well as the subscript a have been described previously.

Most preferably all of the hydrolyzable silane groups contained in the composition are ethoxysilane groups, especially triethoxysilane groups. The advantage of such a composition in which all hydrolyzable silane groups are identical, especially ethoxysilane groups, lies in the fact that the properties of the composition are not influenced during storage by disadvantageous ether exchanges on the silane groups. Since different alkoxy groups on the silanes as a rule lead to different reaction rates of these silane groups, ether exchanges can lead to the fact that a silane group intended as a quickly-reacting silane group, for example that of a drying agent, suddenly begins reacting more slowly after prolonged storage. The use of exclusively identical alkoxysilane groups can guarantee constant properties of the composition even after prolonged storage of, for example, half a year or more.

In a generally preferred embodiment the silane-functional polymer P is a silane-functional polymer P1 and has only triethoxysilane groups as the silane groups. Furthermore silane-containing additives that may be present have only triethoxysilane groups or alkyldiethoxysilane groups as the silane groups, especially methyl- or ethyldioxysilane groups, and preferably triethoxysilane groups.

It is advantageous to select all of the constituents optionally present in the composition, especially fillers and catalysts, in such a way that the storage stability of the composition is not negatively influenced by the presence of such constituents, in other words, that the composition shows little or no change in its properties during storage, especially its application and curing properties. This means that reactions leading to chemical curing of the compositions described, especially of the silane groups, do not take place to a significant extent during storage. It is therefore particularly advantageous that the constituents mentioned do not contain or release during storage, or at least maximally contain or release only traces, of water. For this reason it may be reasonable to chemically or physically dry certain constituents before mixing into the composition.

The above-described composition is preferably produced and stored under exclusion of moisture. Typically the composition is stable in storage, in other words it can be stored under exclusion of moisture in a suitable package or system, for example a drum, a bag or a cartridge, over a period of several months up to one year or longer, without its application properties or its properties after curing changing to an extent that is relevant for its use. Usually the storage stability is ascertained by measuring the viscosity or the expulsion force.

During the application of the described composition to at least one solid or article, the silane groups contained in the composition come into contact with moisture. The silane groups have the property of hydrolyzing upon contact with moisture. In this process organosilanols form, and, by subsequent condensation reactions, also organosiloxanes. As a result of these reactions, which can be accelerated by the use of catalysts, the composition finally cures. This process is also known as cross-linking.

The water needed for curing can come from the air (humidity), or the previously described composition can be brought into contact with a component containing water, for example by painting, for example with a smoothing agent, or by spraying, or a water-containing component can be added to the composition during its application, for example in the form of a water-containing paste, which for example is mixed into a static mixer. In the case of curing by atmospheric humidity the composition cures from outside to inside. The rate of curing is determined by various factors, for example the diffusion rate of the water, the temperature, the ambient humidity and the geometry of the bond, and as a rule becomes slower as curing progresses.

Furthermore the present invention comprises the use of an above-described composition as an adhesive, sealant or coating.

The composition according to the invention is especially used in a method of bonding two substrates S1 and S2 comprising the steps
i) Application of a compound according to the preceding description to a substrate S1 and/or substrate S2;
ii) Contacting the substrates S1 and S2 over the applied composition within the open time of the composition;
iii) Curing the composition with water;
   wherein the substrates S1 and S2 are the same as or different from one another.

Furthermore the composition according to the invention can also be used in the method of sealing or coating comprising the steps
i′) Application of a composition according to the above description to a substrate S1 and/or between two substrates S1 and S2;
ii′) Curing the composition with water, especially in the form of atmospheric humidity;
   wherein the substrates S1 and S2 are the same as or different from one another.

Particularly suitable as substrates S1 and/or S2 are substrates selected from the group consisting of concrete, mortar, brick, tile, plaster, a natural rock such as granite or marble, glass, glass ceramic, metal or metal alloy, wood, plastic and paint.

The composition according to the invention preferably has a pasty consistency with structurally viscous characteristics. Such a composition is applied using a suitable device to the substrate, preferably in the form of a bead, wherein this advantageously has an essentially round or triangular cross-sectional area. Suitable methods for applying the composition are, for example, application from commercial cartridges, operated manually or using compressed air, or from a drum or hobbock using a feed pump or extruder, possibly by means of an application robot. The composition according to the invention with good application characteristics has high creep strength and short stringing. In other words, after application it remains in place in the form as applied, thus does not flow away, and after the application device is lifted it does not draw a thread or draws only a very short thread, so that the substrate is not dirtied.

In addition the invention relates to a cured composition that can be obtained from a composition as described in the preceding after curing with water, especially in the form of atmospheric humidity.

In the case of the articles bonded, sealed or coated with a composition according to the invention, these particularly include a civil engineering construction work, above or below ground, an industrially manufactured object or a consumer item, especially a window, a household appliance, or a means of transport or a component of a transport means.

In addition the present invention relates to the use of a catalyst selected from the group consisting of an organotitanate, organozirconate and organoaluminate, together with a compound that has at least one amidino group for cross-linking silane-terminated polymers with alkoxy end groups that are not methoxy groups. Preferred catalysts and compounds containing at least one amidino group were already described in the preceding.

In addition the invention relates to a catalyst system for the cross-linking of silane-terminated polymers with alkoxy end groups that are not methoxy groups, comprising an organotitanate, organozirconate or organoaluminate, and a compound that has at least one amidino group.

Preferred organotitanates, organozirconates, organoaluminates and compounds containing at least one amidino group were already described in the preceding.

### EXAMPLES

In the following, embodiments are presented to illustrate the invention described in further detail. Naturally the invention is not limited to these embodiments described.

### Test Methods

The tensile strength, the elongation at break, and the modulus of elasticity (E-modulus) at 0 to 100% elongation were determined according to DIN EN 53504 (tensile speed: 200 mm/min) on films with a thickness of 2 mm cured for 7 days at 23° C. and 50% relative humidity.

The tear propagation resistance was determined according to DIN 53515 on films with a thickness of 2 mm cured for 7 days at 23° C. and 50% relative humidity.

The Shore A hardness was determined according to DIN 53505 on test pieces with a thickness of 6 mm cured for 7 days at 23° C. and 50% relative humidity

The skin formation time (“tack-free time”) was determined at 23° C. and 50% relative humidity. To determine the skin formation time a small portion of the adhesive at room temperature was applied to corrugated cardboard in a layer about 2 mm thick and the time required for no residue to remain on the pipette after the surface of the adhesive was tapped lightly with a LDPE pipette was determined.

Preparation of the Silane-Functional Polyurethane Polymer with Ethoxy End Groups P-EtO

Under a nitrogen atmosphere, 700 g Polyol Acclaim® 12200 (Bayer MaterialScience AG, Germany; low monol polyoxypropylene diol; OH number 11.0 mg KOH/g; water content approx. 0.02 wt-%), 32.1 g isophorone diisocyanate (Vestanat® IPDI, Evonik Degussa GmbH, Germany), 85.4 g 2,2,4-trimethyl-1,3-pentanediol diisobutyrate (Eastman TXIB™; Eastman Chemical Company, USA) and 0.4 g Tyzor® IBAY (fromDuPont, USA) were heated under constant agitation to 90° C. and left at this temperature. After one hour of reaction time, a free isocyanate group content of 0.7 wt % by titration was reached. Then 0.14 mol reactive silane (Int-EtO) (corresponding to a stoichiometric reaction of the NCO groups with silane) was added and agitation was continued for an additional 2 to 3 hours at 90° C. The reaction was interrupted as soon as no further free isocyanate was measurable by IR spectroscopy (2275-2230 cm⁻¹). The product was cooled to room temperature (23° C.) and stored under exclusion of moisture (theoretical polymer content=90%).

The reactive silane Int-EtO (N-(3-triethoxysilyl-propyl)-aminosuccinic acid diethyl ester) was produced as follows: 100 g 3-aminopropyltriethoxysilane (Dynasylan® AMEO from Evonik Degussa GmbH, Germany) was taken initially. With thorough agitation, 77.8 g diethyl maleate (Fluka Chemie GmbH, Switzerland) were added slowly at room temperature and the mixture was agitated for 12 hours at 60° C.

### Preparation of the Thixotropic Agent TM

In a Vacuum mixer, 1000 g diisodecyl phthalate (DIDP, Palatinol® Z, BASF SE, Germany) and 160 g 4,4′-diphenylmethane diisocyanate (Desmodur® 44 MC L, Bayer MaterialScience AG, Germany) were placed and slightly heated. Then 90 g monobutylamine were dropped in slowly under vigorous agitation. The white paste produced was further agitated for 1 hour under vacuum and cooling. The thixotropic agent TM contains 20 wt % thixotropic agent in 80 wt % diisodecyl phthalate.

### Preparation of Adhesive

Corresponding to the parts by weight given in Tables 1 to 3, the silane-functional polymer P-EtO, DIDP, thixotropic agent TM and vinyltriethoxysilane (Dynasylan® VTEO from Evonik Degussa GmbH, Germany) were well mixed for 5 minutes in a vacuum mixer. Then dried, precipitated chalk (Socal® U1S2, Solvay SA, Belgium) and powdered chalk (Omyacarb® 5-GU, Omya AG, Switzerland) were kneaded in for 15 minutes at 60° C. Then with the heat turned off, 3-aminopropyl-triethoxysilane (Dynasylan® AMEO), catalyst and optionally a compound, containing at leas one amidino group were processed under vacuum for 10 minutes to form a homogeneous paste. This was then filled into expanding plunger aluminum cartridges painted on the inside.

TABLE 1
Adhesive compositions in parts by weight and results

| | 1 | 2 | 3 | 4 | 5 |
|---|---|---|---|---|---|
| P-EtO | 13 | 13 | 13 | 13 | 13 |
| DIDP | 19 | 19 | 19 | 19 | 19 |
| TM | 2 | 2 | 2 | 2 | 2 |
| Dynasylan ® VTEO | 1 | 1 | 1 | 1 | 1 |
| Socal ® U1S2 | 11 | 11 | 11 | 11 | 11 |
| Omyacarb ® 5-GU | 52 | 52 | 52 | 52 | 52 |
| Dynasylan ® AMEO | 0.5 | 0.5 | 0.5 | 0.5 | 0.5 |
| Metatin ® K712^{a)} | 1 | | | 1 | |
| Tyzor ® IBAY | | 1 | | | 1 |
| DBU^{b)} | | | 0.2 | 0.2 | 0.2 |
| Cured after 1 week | No | No | No | No | Yes |

^{a)}10% solution in DIDP;
^{b)}DBU (1,8-diazabicyclo[5.4.0]undec-7-ene) available from BASF SE, Germany.

TABLE 2
Adhesive compositions in parts by weight and results

| | 5 | 6 | 7 | 8 | 9 | 10 | 11 |
|---|---|---|---|---|---|---|---|
| P—EtO | 13 | 13 | 13 | 13 | 13 | 13 | 13 |
| DIDP | 19 | 19 | 19 | 19 | 19 | 19 | 19 |
| TM | 2 | 2 | 2 | 2 | 2 | 2 | 2 |
| Dynasylan ® VTEO | 1 | 1 | 1 | 1 | 1 | 1 | 1 |
| Socal ® U1S2 | 11 | 11 | 11 | 11 | 11 | 11 | 11 |
| Omyacarb ® 5-GU | 52 | 52 | 52 | 52 | 52 | 52 | 52 |
| Dynasylan ® AMEO | 0.5 | 0.5 | 0.5 | 0.5 | 0.5 | 0.5 | 0.5 |
| Tyzor ® IBAY | 1 | 1 | 1 | 1 | 1 | 1 | 1 |
| DBU | 0.2 | | | | | | |
| Tetramethyl- | | 0.2 | | | | | |
| guanidine ^{a)} | | | | | | | |
| Methylimidazole ^{a)} | | | 0.2 | | | | |
| N-(3-Triethoxysilyl- | | | | 0.2 | | | |
| propyl)-4,5-dihydro- | | | | | | | |
| imidazole ^{b)} | | | | | | | |
| DMDEE ^{c)} | | | | | 0.2 | | |
| DMP ^{d)} | | | | | | 0.2 | |
| 1,4- | | | | | | | 0.2 |
| Diazabicyclo[2.2.2]- | | | | | | | |
| octane ^{e)} | | | | | | | |
| Cured after 1 week | Yes | Yes | Yes | Yes | No | No | No |
| Tensile strength | 0.8 | 0.8 | 0.4 | 0.6 | n.d. | n.d. | n.d. |
| [MPa] | | | | | | | |
| Elongation at break | 416 | 536 | 148 | 240 | n.d. | n.d. | n.d. |
| [%] | | | | | | | |
| E-Modulus 0-100% | 0.5 | 0.7 | 0.3 | 0.4 | n.d. | n.d. | n.d. |
| [MPa] | | | | | | | |
| Tear propagation | 5.8 | 5.9 | 1.7 | 4.5 | n.d. | n.d. | n.d. |
| resistance [N/mm] | | | | | | | |
| Skin formation time | 40 | 120 | >8 h | 80 | n.d. | n.d. | n.d. |
| [min] | | | | | | | |
| Shore A | 31 | 29 | 8 | 25 | n.d. | n.d. | n.d. |

^{a)} available from Fluka Chemie GmbH, Switzerland;
^{b)} available from Gelest, Inc., USA;
^{c)} DMDEE (2,2′-dimorpholino diethyl ether) available as Jeffcat ® DMDEE from Huntsman Corporation, USA;
^{d)} DMP (Dimethylpiperazine) available as Jeffcat ® DMP from Huntsman Corp.;
^{e)} available as Jeffcat ® TD-100 from Huntsman Corp.;
n.d.: not determined, since no curing after 1 week.

TABLE 3
Adhesive compositions in parts by weight and results

| | 5 | 12 | 13 | 14 | 15 | 16 |
|---|---|---|---|---|---|---|
| P—EtO | 13 | 13 | 13 | 13 | 13 | 13 |
| DIDP | 19 | 19 | 19 | 19 | 19 | 19 |
| TM | 2 | 2 | 2 | 2 | 2 | 2 |
| Dynasylan ® VTEO | 1 | 1 | 1 | 1 | 1 | 1 |
| Socal ® U1S2 | 11 | 11 | 11 | 11 | 11 | 11 |
| Omyacarb ® 5-GU | 52 | 52 | 52 | 52 | 52 | 52 |
| Dynasylan ® AMEO | 0.5 | 0.5 | 0.5 | 0.5 | 0.5 | 0.5 |
| DBU | 0.2 | 0.2 | 0.2 | 0.2 | 0.2 | 0.4 |
| Tyzor ® IBAY | 1 | | | | | |
| Tytan ™ ET ^{a)} | | 1 | | | | |
| Tytan ™ TAA ^{a)} | | | 1 | | | |
| Tytan ™ PBT ^{a)} | | | | 1 | | |
| Snapcure ™ 1020 ^{b)} | | | | | 1 | |
| K-Kat ® 5218 ^{c)} | | | | | | 1 |
| Tensile strength | 0.8 | 1 | 0.8 | 0.9 | 0.3 | 0.8 |
| [MPa] | | | | | | |
| Elongation at break | 416 | 156 | 434 | 154 | 140 | 443 |
| [%] | | | | | | |
| E-Modulus 0-100% | 0.5 | 0.9 | 0.5 | 0.8 | 0.2 | 0.4 |
| [MPa] | | | | | | |
| Tear propagation | 5.8 | 5 | 6.1 | 5.3 | 1.3 | 4 |
| resistance [N/mm] | | | | | | |
| Skin formation time | 40 | 80 | 20 | 80 | ~1000 | 210 |
| [min] | | | | | | |
| Shore A | 31 | 44 | 36 | 38 | 12 | 32 |

^{a)} available from TensoChema AG, Switzerland;
^{b)} available from Johnson Matthey & Brandenberger AG, Switzerland;
^{c)} available from Worlée-Chemie GmbH, Germany.

1. Composition comprising
a) at least one silane-functional polymer P with alkoxy end groups that are not methoxy groups;
b) at least one catalyst for the cross-linking of silane-functional polymers, selected from the group consisting of an organotitanate, organozirconate and organoaluminate;
c) at least one compound containing at least one amidino group.

2. Composition according to claim 1, wherein the alkoxy end groups of the silane-functional polymer P, are end groups of formula (I) 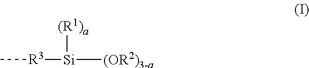
where
R¹ represents an alkyl group with 1 to 8 C atoms;
R² represents an alkyl group with 2 to 12 C atoms;
R³ represents a linear or branched, optionally cyclic, alkylene group with 1 to 12 C atoms, optionally with aromatic fractions, and optionally with one or more heteroatoms; and
a represents a value of 0 or 1 or 2.

3. Composition according to claim 1, wherein the alkoxy end groups of the silane-functional polymer P are ethoxy groups.

4. Composition according to claim 1, wherein the catalyst for the cross-linking of silane-functional polymers has at least one multidentate ligand.

5. Composition according to claim 1, wherein the catalyst for the cross-linking of silane-functional polymers is an organotitanate.

6. Composition according to claim 5, wherein the organotitanate is an organotitanate of formula (VIII) 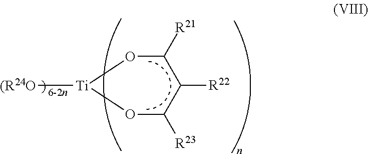
where
R²¹ represents a hydrogen atom or represents a linear or branched alkyl group with 1 to 8 C atoms;
R²² represents a hydrogen atom or represents a linear or branched alkyl group with 1 to 8 C atoms, which optionally contains hetero atoms;
R²³ represents a hydrogen atom or represents an alkyl group with 1 to 8 C atoms or represents a linear or branched alkoxy group with 1 to 8 C atoms;
R²⁴ represents a linear or branched alkyl radical with 2 to 20 C atoms; and n represents a value of 1 or 2.

7. Composition according to claim 1, wherein the compound which has at least one amidino group is a compound of formula (IX) 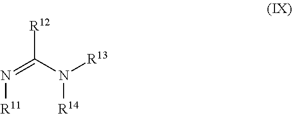
where
R¹¹ represents a hydrogen atom, a monovalent hydrocarbon radical with 1 to 10 C atoms or together with R¹⁴ represents an optionally substituted, divalent hydrocarbon radical with 1 to 10 C atoms;
R¹² represents a hydrogen atom, a monovalent hydrocarbon radical with 1 to 12 C atoms, optionally with cyclic or aromatic fractions, and optionally with one or more hetero atoms, an amino group or together with R¹³ represents an optionally substituted, divalent hydrocarbon radical with 1 to 10 C atoms;
R¹³ represents a hydrogen atom, a monovalent hydrocarbon radical with 1 to 12 C atoms, optionally with cyclic ode aromatic fractions, and optionally with one or more hetero atoms or together with R¹² represents an optionally substituted, divalent hydrocarbon radical with 1 to 10 C atoms; and
R¹⁴ represents a hydrogen atom, a monovalent hydrocarbon radical with 1 to 10 C atoms or together with R¹¹ represents an optionally substituted, divalent hydrocarbon radical with 1 to 10 C atoms.

8. Composition according to claim 1, wherein the compound which has at least one amidino group is a guanidine, an imidazole, an imidazoline, a bicyclic amidine or a derivative of these compounds.

9. Composition according to claim 1, wherein the composition is substantially free from tin or organic tin compounds.

10. Composition according to claim 1, wherein the composition contains no constituents that split off methanol when curing.

11. Composition according to claim 1, wherein the fraction of the catalyst amounts to 0.1 to 10 wt % of the total composition.

12. Composition according to claim 1, wherein the fraction of the compound that has at least one amidino group amounts to 0.05 to 3 wt % of the total composition.

13. The composition according to claim 1, used as adhesive, sealant or coating.

14. The catalyst selected from the group consisting of an organotitanate, organozirconate and organoaluminate, together with a compound containing as least one amidino group for cross-linking of silane-terminated polymers with alkoxy end groups that are not methoxy groups.

15. Catalyst system for the cross-linking of silane-terminated polymers with alkoxy end groups that are not methoxy groups, comprising an organotitanate, organozirconate or organoaluminate, as well as a compound that has at least one amidino group.
